(19) United States
(12) Patent Application Publication
(10) Pub. No.: US 2016/0378735 A1
(43) Pub. Date: Dec. 29, 2016

(54) METAMORPHIC DOCUMENTS

(71) Applicant: Microsoft Technology Licensing, LLC, Redmond, WA (US)

(72) Inventors: Christopher Lee Mullins, Sammamish, WA (US); Jonathan Edgar Fay, Woodinville, WA (US)

(21) Appl. No.: 14/754,437

(22) Filed: Jun. 29, 2015

(51) Int. Cl. G06F 17/22; G06T 11/20; G06F 17/21; G06F 17/24; G06F 3/0484; G06F 3/0482

(52) U.S. Cl. CPC G06F 17/2288; G06F 3/04842; G06F 3/0482; G06F 17/212; G06F 17/24; G06F 17/2241; G06F 17/2211; G06F 17/246; G06F 17/245; G06F 17/2264; G06T 11/206

(57) ABSTRACT

A facility for presenting document contents is described. The facility receives input denoting selection of one of a plurality of visualization forms. The facility renders the document contents in accordance with the visualization form whose selection is denoted by the received input, and causes the rendered document contents to be displayed.

### BACKGROUND

It is common for electronic documents to be rigorously categorized into types: word processing documents containing mostly text; spreadsheets containing mostly numbers and formulae organized into a grid; slideshow documents organized into a sequence of slides having room for minimal content based on the typical need for them to be legible at a distance; business drawings in which text is associated with shapes connected in a particular configuration, etc. This rigorous categorization is related to the fact that different documents of different types are typically created and edited using different, monolithic applications. For example, word processing documents tend to be created and edited using a different application than spreadsheet documents.

### SUMMARY

A facility for presenting document contents is described. The facility receives input denoting selection of one of a plurality of visualization forms. The facility renders the document contents in accordance with the visualization form whose selection is denoted by the received input, and causes the rendered document contents to be displayed.

This summary is provided to introduce a selection of concepts in a simplified form that are further described below in the Detailed Description. This summary is not intended to identify key factors or essential features of the claimed subject matter, nor is it intended to be used to limit the scope of the claimed subject matter.

### BRIEF DESCRIPTION OF THE DRAWINGS

FIG. 1 is a network diagram showing the environment in which the facility operates in some embodiments.

FIG. 2 is a block diagram showing some of the components typically incorporated in at least some of the computer systems and other devices on which the facility operates.

FIGS. 3-5 are display diagrams showing the editing and display of a document incorporating a shared document fragment.

FIG. 6 is a flow diagram showing steps typically performed by the facility in some embodiments in order to incorporate a document fragment into a document, and adjust the mode of its incorporation.

FIG. 7 is a flow diagram showing steps typically performed by the facility in some embodiments in order to materialize a document containing shared fragments.

FIG. 8 is a table diagram showing sample contents of a fragment directory table used by the facility in some embodiments to store information about fragments.

FIG. 9 is a table diagram showing sample contents of a fragment version table used by the facility in some embodiments to store information about fragment versions.

FIG. 10 is a table diagram showing sample contents of a fragment version instance table used by the facility in some embodiments to store information about fragment version instances.

FIG. 11 is a table diagram showing sample contents of a fragment version instance content table used by the facility in some embodiments to store fragment version instance content.

FIG. 12 is a flow diagram showing steps typically performed by the facility in some embodiments in order to provide access to documents in any of a number of available visualization forms selected arbitrarily by a user.

FIGS. 13-20 are display diagrams depicting an example in which multiple users concurrently edit a sample document in a variety of presentation forms.

FIG. 21 is a table diagram showing sample contents of a visualization form table used by the facility in some embodiments to represent the set of visualization forms that are available for use by users to present documents.

### DETAILED DESCRIPTION

### Overview

The inventors have recognized significant disadvantages in conventional electronic documents. In particular, the inventors have noted that, while different ways of visualizing electronic content each have their own advantages, by limiting each document type in many cases to a single visualization form, conventional documents preclude obtaining the advantages that would attend other visualization forms.

The inventors have further recognized that conventional techniques available to transform an electronic document from its initial visualization form to other visulation forms are in many ways problematic: each such transformation can be a difficult process; the resulting separate documents must be stored separately, incurring redundant storage resources, and siloing these separate documents representing different visualization forms such that revisions to one of these documents have no effect on the other documents.

In order to overcome these disadvantages, the inventors have conceived and reduced to practice a software and/or hardware facility for allowing each user accessing a document to select any of a number of diverse visualization forms available for presenting the document (“the facility”).

A visualization form specifies a manner of transforming document contents into a particular visualization for presentation. For example, in various embodiments, the facility makes available various combinations of visualization forms such as a word processing visualization form; a spreadsheet visualization form; a chart visualization form; a slideshow visualization form; a calendar visualization form; an organizational, graph-based visualization form; an outline visualization form; a table of contents; etc. The facility is extensible, in that new visualization forms may be added over time. For example, a newly created visualization form may be added to allow existing document contents to be viewed in a new way.

In some embodiments, at least some of the visualization forms made available by the facility explicitly denote the organizational structure of the documents that they are used to present. A user can edit a document in one of these visualization forms in order to alter the organizational structure of the document, such as by inserting a new node in the organizational structure of the document, relocating a node within the organizational structure of the document, deleting a note in the organizational structure of the document, etc.

Each visualization form may specify certain document content for presentation. For example, a word processing visualization form may present all document content, while a slideshow visualization form may present a subset of the document content (e.g., headings, topic sentences, images) more suitable for display in a slide presentation.

In some embodiments, any user may select the visualization form that they use to present a document, and may switch to a new visualization form at any point. For example, a user may begin with a structural organization visualization form that as well-suited to navigating a document; then switch to a filmstrip visualization form in which it is easy to insert new images; then switch to a word processing visualization form in which it is easy to edit text; then switch to a slideshow visualization form visualization form in which most users of the document will view it.

Different users can use different visualization forms to present the same document, even concurrently. Many visualization forms provided by the facility enable the user to edit a document in a manner that alters the underlying content of the document, and accordingly the contents of the document being presented to users using different visualization forms.

In some embodiments, the facility stores documents using a construct called a “document fragment,” or simply “fragment,” which is a unit of document content represented separately by the facility. The document is comprised of a single “root fragment,” which can directly contain content, as well as containing fragment references referring to other fragments. Those fragments referred to by the root fragment can themselves directly contain content and fragment references to other fragments, and so on. When a document is opened, the facility typically collects and synthesizes its contents by retrieving the root fragment, retrieving other fragments referred to by fragment references in the root fragment, retrieving further fragments referred to by fragment references in those fragments, and so on. In some embodiments, any fragment can be treated as a document, in the sense that it can be opened by an editing or presentation application as the root fragment.

In some embodiments, the facility stores the fragments making up users' documents in a cloud-based service, where they can be accessed from virtually any location. In some embodiments, this cloud-based service uses a technique called “erasure coding” in which it decomposes, or “shreds,” a fragment defined by a document author into multiple smaller constituent pieces, or “shreds,” each of which the facility stores on multiple storage devices in different data centers in different geographic locations to provide disaster and outage survivability. When the cloud-based service receives a request for a fragment, it retrieves and combines these shreds to reconstitute the fragment.

In some embodiments, the facility stores a new version of a fragment to reflect each editing action performed on the fragment, each identified by the date and time at which the editing action was performed. For example, in some embodiments, the facility creates a new fragment version for each character or group of characters that is inserted in the fragment—such as by a keystroke or a text block paste—and for each character or group of characters that is deleted—such as by a backspace keypress or a select-and-delete operation. In some embodiments, each fragment version identifies the author that took the editing action reflected by the fragment version. In some embodiments, after being written, these fragment versions cannot be altered, and are said to be “immutable.”

In some embodiments, over time, the facility deletes some of the versions of a fragment, so as to collapse two or more editing actions into an undeleted version of the fragment. In some embodiments, in doing so, the facility deletes only contiguous fragment versions all reflecting editing actions by the same author and immediately preceding an undeleted fragment version also reflecting an editing action by the same author.

In some embodiments, where the content is incorporated from a fragment-aware source document, the facility ensures that the incorporated content corresponds precisely to one or more whole fragments; that is, where the selected content spans only a portion of a fragment in the source document, the facility breaks that fragment in the source document into two fragments, a first that contains only the content from the original fragment that was selected, a second containing the content from the original fragment that was not selected, so that the first can be incorporated into the target document while the second is not. Where the content is incorporated from a fragment-unaware source document, the facility creates a new fragment to contain the incorporated content.

In response to the incorporation operation, the facility creates a fragment reference in the target document at the position in the target document where the content was incorporated to represent the incorporated content in the target document. In some embodiments, the fragment reference contains multiple components, such as a current fragment ID component and/or an original component. The current fragment ID component of the created fragment reference identifies the fragment to which the reference refers, such as by containing a fragment ID for this fragment that can be used to retrieve this fragment. The origin component, where used by the facility, maintains in the fragment reference state the fragment ID of the fragment in which the incorporated content originated, which can serve as a basis for changing the mode in which the incorporated content is used in the target document throughout the life of the fragment reference, and for tracking the provenance of the fragment. In some embodiments, the facility stores an ordered list of fragment IDs in the origin component to reflect the series of fragments from which the referenced fragment has been forked.

In various embodiments, at the time the user performs the incorporation operation, the user can specify an initial mode for the incorporated content in the target document by, for example, holding down a certain keyboard key during the drag interaction, using a varying control key combination to paste the incorporated content into the target document, responding to a context menu or dialog displayed by the facility in response to the incorporation operation, etc. In some embodiments, each mode has two characteristics: (1) whether the contents of the fragment are editable in the context of the incorporating document or fragment (“editable in context”) and (2) how a version of the referenced fragment is chosen for inclusion in the incorporating document or fragment (“version selection”). In some embodiments, the following kinds of version selection options are available: (a) “latest”—the version of the fragment with the most recent time is incorporated by the reference; (b) “time-specified”—a particular version of the fragment associated with a particular time is incorporated by the reference (e.g., in some embodiments, an arbitrarily specified time causes selection of the fragment version whose time is the latest among the fragments that are not later than the specified time); (c) “special”—special rules are used to specify which version of the fragment is selected for incorporation. Examples of special rules are the latest document approved by a qualified approval authority, or the earliest version embodying an edit by a particular author.

In various embodiments, the facility supports some or all of the following incorporation modes: live mode, follow mode, forkable mode, pinned mode, special forkable mode, and special follow mode.

Live mode (1) is editable in context and (2) uses “latest” version selection. Thus, in live mode, an author can change the content of the fragment, which results in a new version of the fragment being created to reflect each such change. These changes will appear in any other containing fragments that incorporate the same fragment, and whose version selection option ends up selecting this version, either (a) latest, or (b) special with a selection rule that selects this version. Live mode is typically used for a reference included to both revise the referenced fragment, and reflect the revisions of others. By virtue of using the latest version selection option, a reference in live mode incorporates the latest version of the fragment, no matter its content or which authors' revision it reflects. Where live mode is selected, the facility populates a current fragment ID component of the fragment reference with the same fragment ID as the origin component. The current component of the fragment reference identifies the fragment whose contents are to be retrieved for inclusion in the target document.

Follow mode (1) is not editable in context, and (2) uses latest version selection. In follow mode, the latest version of the fragment is always incorporated, but can't be edited in the context of the document or fragment containing the follow mode reference. Follow mode is typically used to incorporated dynamic content maintained by one or more other authors, in a centralized manner.

Forkable mode (1) is editable in context, and (2) uses time-specified version selection. In forkable mode, the fragment can be edited in the context of the reference from the fragment's state at the specified time. Performing such an edit transforms the reference from forkable mode to live mode; reflects the edit in the first version of a new fragment ID; stores the new fragment ID in the context of the reference; and stores the original fragment ID in the reference's origin component. Forkable mode is typically used where a particular state of a fragment is to be the basis for a new set of edits that won't affect documents or fragments incorporating the original fragment. Similarly, the forkable and resulting live reference aren't affected by edits to the original fragment subsequent to the forkable reference version selection time.

Pinned mode (1) is not editable in context, and (2) uses time-specified version selection. While the fragment reference is in pinned mode, the incorporated content cannot be changed, either by a user editing the document or fragment containing the pinned reference (because not editable in context precludes editing by such an author), or by a user editing the fragment in the context of a different containing document or fragment (because such edits will be reflected in a new version of the fragment, which will not be selected by the time-specified selection logic of this reference). Where pinned mode is selected, the facility populates the current component of the fragment reference with the fragment ID of the origin fragment. Pinned mode is typically used to preserve a particular state of the fragment in the referring document.

Special forkable mode (1) is editable in context, and (2) specifies a special version selection rule. The incorporated fragment will, at any given time, show the content of the version of the source fragment that is selected by the special version selection rule at the time. When an author edits the fragment in context, the forking process described above occurs. Special forkable mode can be used, for example, to use an evolving template whose edits are subject to periodic approval as a basis for creating instances of new content.

Special follow mode (1) is not editable in context, and (2) specifies a special version selection rule. Thus, a special follow reference shows the version of the fragment that satisfies the version selection rule at any given time, which is not editable in context. This mode can be used, for example, to pull into a document or fragment centrally-authored content that is periodically rereleased by its authors to reflect all edits occurring since the last release.

A user may at any subsequent time change the mode of the incorporated content via various user interface techniques, such as by right-clicking on the incorporated content and selecting an item from a resulting context menu, selecting incorporated content and choosing a menu-bar menu item, interacting with a specialized control that is displayed when the mouse cursor hovers over the incorporated content, etc. In some embodiments, the facility incorporates or interoperates with a system of authority and access controls and other content governance measures limit the actions that can be taken by a particular user with respect to a particular document or fragment in various circumstances, including changing the mode of an existing fragment reference.

In some embodiments, when retrieving the time-specified fragment version for content incorporated in pinned mode, the facility notifies the user if a version of the origin fragment that is more recent than the read-only fragment to enable the user to switch the mode to live, or remain in pinned mode but replace the time specified for the version in the reference with the time corresponding to the latest version.

In some embodiments, the facility maintains metrics on the incorporation of fragments into documents to be able to report on various “hot fragments” measures, which identify fragments that are incorporated into the most total documents, or fragments that have been incorporated into the most documents during a recent period of time, across an organization or another group of users, among a group or category of documents, etc.

By operating in some or all of the ways described above, the facility enables users to create, revise, collaborate on, and present documents in diverse and powerful ways.

### Hardware

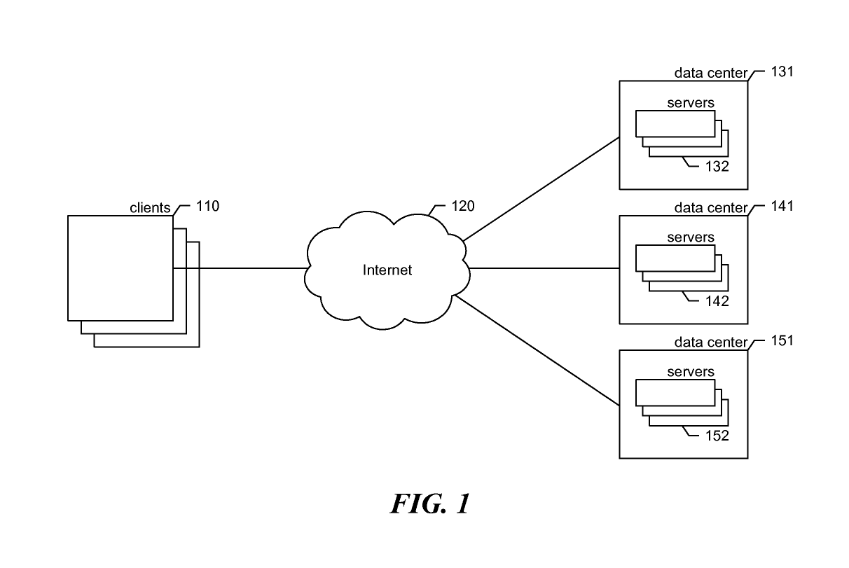

FIG. 1 is a network diagram showing the environment in which the facility operates in some embodiments. The network diagram shows clients 110 each being used by a different user. Each of the clients executes software enabling its user to create, revise, and present electronic documents. Software on the client also enables the client to retrieve and synthesize remotely-stored document contents, including document fragments. In particular, the Internet 120 or one or more other networks connect each of the clients to a number of different data centers, e.g., data centers 131, 141, and 151, which in some embodiments are distributed geographically to provide disaster and outage survivability, both in terms of data integrity and in terms of continuous availability. Distributing the data centers geographically also helps to minimize communications latency with clients in various geographic locations. Each of the data centers contain servers, e.g. servers 132, 142, and 152. The servers access storage devices containing document contents, including document fragments, and execute software for responding to requests from clients and other servers to store and retrieve document contents, again including document fragments. In various embodiments, the facility uses various different distributions of responsibility for retrieving and combining document fragments between the clients and the servers.

While various embodiments are described in terms of the environment described above, those skilled in the art will appreciate that the facility may be implemented in a variety of other environments including a single, monolithic computer system, as well as various other combinations of computer systems or similar devices connected in various ways. In various embodiments, a variety of computing systems or other different devices may be used as clients, including desktop computer systems, laptop computer systems, automobile computer systems, tablet computer systems, smart phones, personal digital assistants, televisions, cameras, etc.

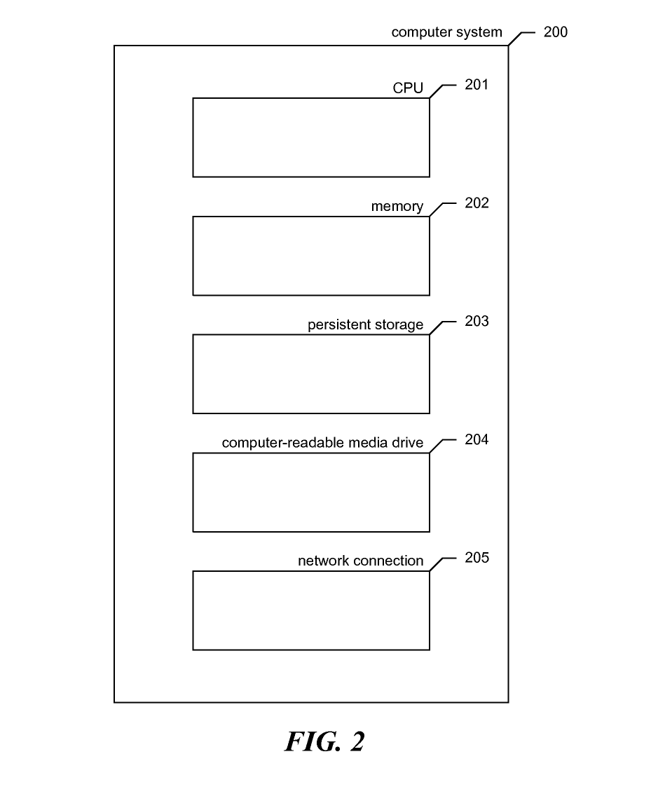

FIG. 2 is a block diagram showing some of the components typically incorporated in at least some of the computer systems and other devices on which the facility operates. In various embodiments, these computer systems and other devices 200 can include server computer systems, desktop computer systems, laptop computer systems, netbooks, mobile phones, personal digital assistants, televisions, cameras, automobile computers, electronic media players, etc. In various embodiments, the computer systems and devices include zero or more of each of the following: a central processing unit (“CPU”) 201 for executing computer programs; a computer memory 202 for storing programs and data while they are being used, including the facility and associated data, an operating system including a kernel, and device drivers; a persistent storage device 203, such as a hard drive or flash drive for persistently storing programs and data; a computer-readable media drive 204, such as a floppy, CD-ROM, or DVD drive, for reading programs and data stored on a computer-readable medium; and a network connection 205 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

### Fragment Management

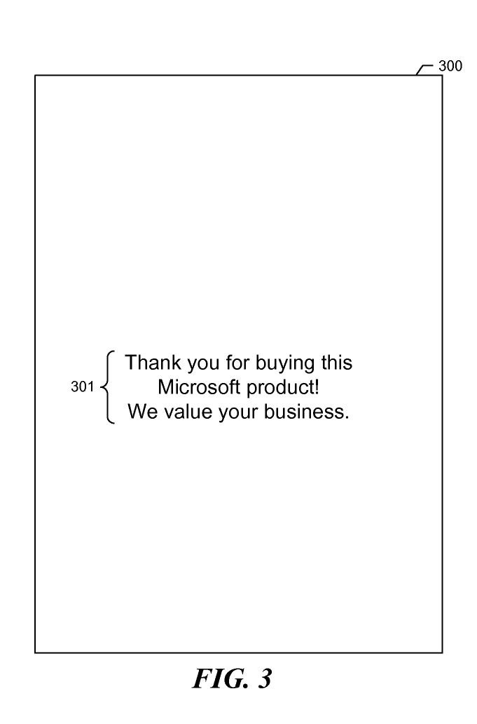

FIGS. 3-5 are display diagrams showing the editing and display of a document incorporating a shared document fragment. FIG. 3 is a display diagram showing a sample target document at a time before the shared document fragment is incorporated. The target document 300 includes text 301. This text may be directly contained by the root fragment for the target document, or may be contained by a fragment identified by a fragment reference within the root fragment for the target document.

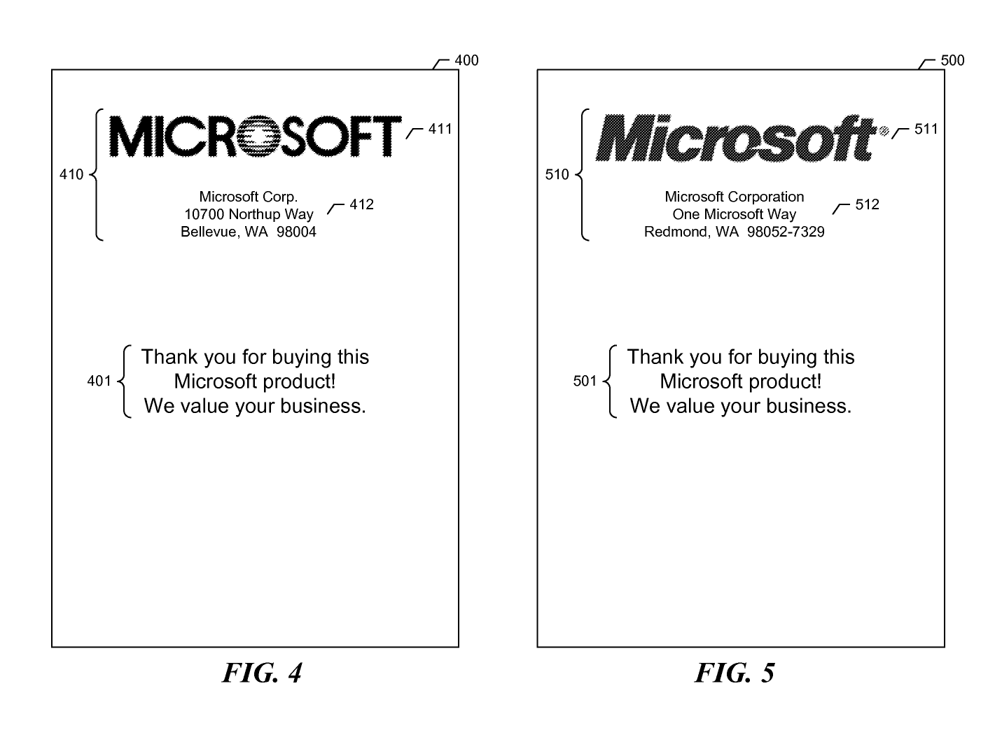

FIG. 4 is a display diagram showing the sample target document at a time immediately after the shared document fragment is incorporated. At this time, the target document 400, in addition to containing text 401, contains incorporated content 410 transferred from a source document (not shown). The incorporated content constitutes a company's letterhead, including both an image 411 of the company's logo and the company's textual address 412.

Where the user incorporates the letterhead content in pinned mode, the letterhead content will remain unchanged in the target document unless and until the incorporation is changed to a different mode. Where the user incorporates the letterhead content in forked mode, the user can change the letterhead content in the context of the target document; such changes will not affect the letterhead content in the source document, and any changes to letterhead content in the source document will not be reflected in the target document. Where the user incorporates the letterhead content in live mode, the user can, subject to any applicable permissions, change the letterhead content in the context of the target document, and doing so will change the letterhead content in the source document and any other document that incorporates the letterhead content in live mode. Similarly, changes to the letterhead content via the source document or any other document that incorporates the letterhead content in live mode will be reflected in the target document.

FIG. 5 is a display diagram showing the sample target document where, after the shared document fragment is incorporated into the target document in live mode, the content is changed in the context of the source document, such as by another user. It can be seen that, in the target document 500 at this time, the letterhead content 510 contains a new company logo 511 and a new company address 512, both substituted in the context of the source document, and reflected in the target document pursuant to the target document's incorporation of this content in live mode.

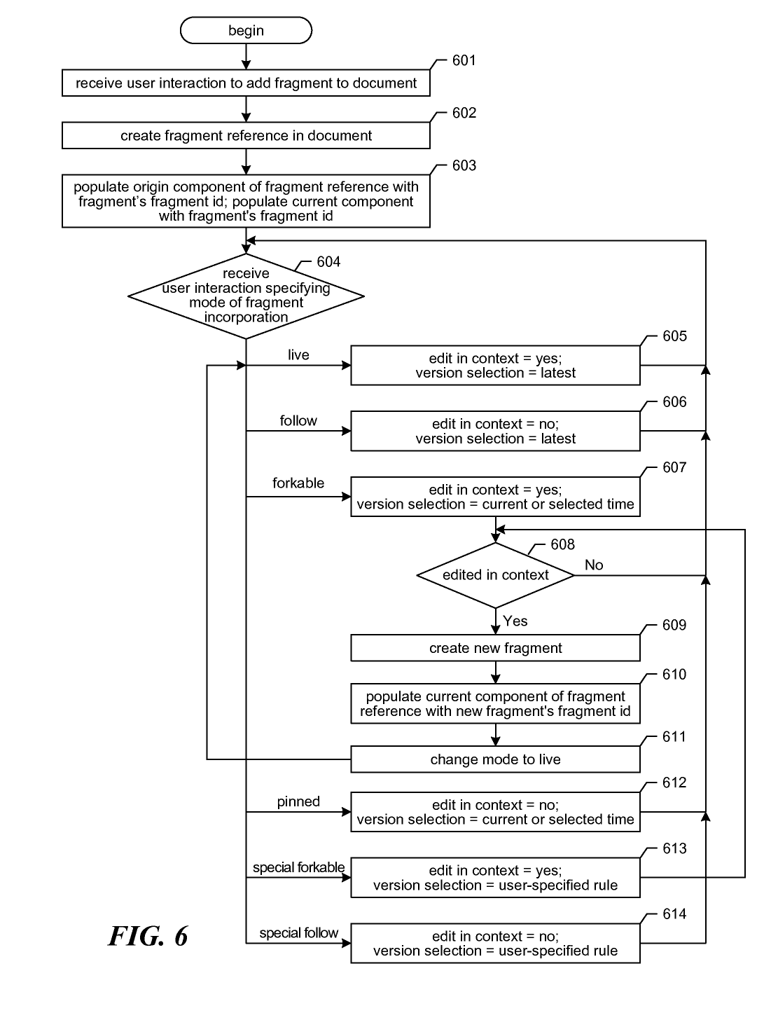

FIG. 6 is a flow diagram showing steps typically performed by the facility in some embodiments in order to incorporate a document fragment into a document, and adjust the mode of its incorporation. In step 601, the facility receives a user interaction to add a fragment to a target document. In various embodiments, such interactions can be, for example, copying the selected content onto the clipboard, then pasting it into the target document at the target position; dragging the selected content from the source document to the target position in the target document; etc. Where the user selects content to add to the target document that don't exactly correspond to whole existing fragments, the facility creates one or more fragments to which the selected content does exactly correspond, such as by subdividing fragments that occur in the source document. In some cases, this involves altering and/or adding fragment references in the source document, and in one or more other documents incorporating the same content in live mode.

In step 602, the facility creates a fragment reference in the target document. In step 603, the facility populates both the origin component of the fragment reference and its current component with the fragment ID of the fragment added to the document. In step 604, the facility receives a user interaction specifying a mode for incorporating the fragment in the target document. In some embodiments, a single interaction or a related sequence of interactions can both add the fragment to the document and specify a mode. If the user action received in step 604 specifies the live mode, then the facility continues in step 605; if it specifies the follow mode, then the facility continues in step 606; if it specifies the forkable mode, then the facility continues in step 607; if it specifies the pinned mode, then the facility continues in step 612; if it specifies the special forkable mode, then the facility continues in step 613; and if it specifies the special follow mode, then the facility continues in step 614.

In step 605, where the live mode is specified, the facility sets edit in context to yes for the reference, and sets version selection to latest. After step 605, the facility continues in step 604 to permit the user to, at a later time, specify a new mode for this fragment. In step 606, where the follow mode is specified, the facility sets edit in context to no for the reference, and sets version selection to latest. After step 606, the facility continues in step 604. In step 607, where the forkable mode is specified, the facility sets edit in context to yes for the reference, and sets version selection to the current time, or an earlier time selected by the user. In step 608, if the user chooses to edit the fragment in the context of the reference, then the facility continues in step 609, else the facility continues in step 604. In step 609, the faculty creates a new fragment that reflects application of the edit of step 608 to the added fragment. The new fragment has a different fragment ID than the added fragment. In step 610, the facility populates the current component of the fragment reference with the new fragment's fragment ID. In step 611, the facility changes the reference's mode to live. After step 611, the facility continues in step 605. In step 612, where the pinned mode is specified, the facility sets edit in context to no for the reference, and sets version selection to the current time, or to an earlier time selected by the user. After step 612, the facility continues in step 604. In step 613, where the special forkable mode is specified, the facility sets edit in context to yes, and sets version selection to a version selection rule, such as a version selection rule specified via additional user interactions, a default version selection rule, an inferred version selection rule, etc. After step 613, the facility continues in step 608. In step 614, where the special follow mode is specified, the facility sets edit in context to no, and sets version selection to a version selection rule in a manner similar to step 613. After step 614, the facility continues in step 604.

Those skilled in the art will appreciate that the steps shown in FIG. 6 and in each of the flow diagrams discussed below may be altered in a variety of ways. For example, the order of the steps may be rearranged; some steps may be performed in parallel; shown steps may be omitted, or other steps may be included; a shown step may be divided into sub steps, or multiple shown steps may be combined into a single step, etc.

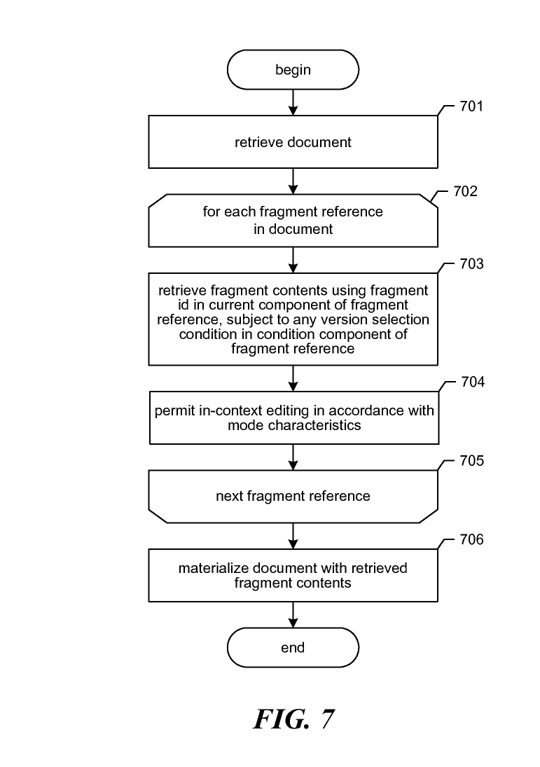

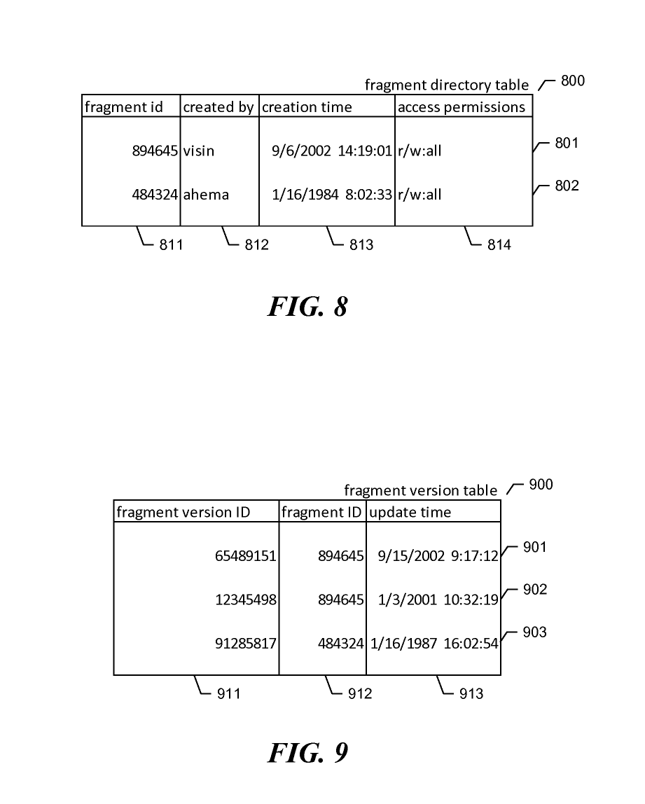

FIG. 7 is a flow diagram showing steps typically performed by the facility in some embodiments in order to materialize a document containing shared fragments. In various embodiments, the facility performs these steps when a document is opened, when a document needs to be displayed, when a user attempts to add it to document, etc. In various embodiments, the facility's performance of these steps is distributed between the client and servers in various ways. In step 701, the facility retrieves a document, such as by retrieving its root fragment. The facility loops through steps 702-704 for each fragment reference occurring in the document, including transitive fragment references from one fragment to another. In step 703, the facility retrieves content of the fragment using the fragment ID contained in the current component of the fragment reference. This retrieval is subject to any version selection condition contained in the condition component of the fragment reference; that is, the retrieval is performed with respect to the latest version of the fragment that specifies any contained version selection condition, or, absent a version selection condition, the latest version of the fragment. In various embodiments, the facility uses various forms of fragment version selection logic. In some embodiments, the process of retrieving a fragment indicates permissions associated with the fragment, including whether the fragment can be edited by the current user, which the facility uses to indicate and control whether the user can edit the fragment in the context of the document. Fragment retrieval is discussed in greater detail below in connection with FIGS. 8-11. In step 704, the facility makes the fragment editable in context based on the mode of the fragment reference. In step 705, if additional fragment references remain to be processed, then the facility continues in step 702 to process the next fragment reference, else the facility continues in step 706. In step 706, the facility materializes the document using the fragment contents retrieved in step 703. After step 706, these steps conclude. In some embodiments (not shown), rather than performing the processing shown in FIG. 7 in a loop, the facility performs it as a recursive descent of a tree-like graph with lenses acting as parents of content nodes, and modifying rendering behavior as the document is materialized.

FIG. 8 is a table diagram showing sample contents of a fragment directory table used by the facility in some embodiments to store information about fragments. In some embodiments, the fragment directory table, and the other tables described in FIGS. 9-11, are stored in a data center on a storage device accessible to servers executing server software that is part of the facility. In some embodiments, some or all of these tables are stored in multiple data centers in order to provide survivability and a measure of locality for the data they store. The fragment directory table 800 is made up of rows such as rows 801-802 each corresponding to a different fragment. Each row is divided into the following columns: a fragment ID column 811 containing a fragment ID identifying the fragment to which the row corresponds; a created by column 812 containing information identifying a user that created the fragment; a creation time column 813 having contents indicating the time at which the fragment was created; and an access permissions column 814 specifying the ways in which the fragment can be accessed by various users. For example, row 801 indicates that a fragment having fragment ID 894645 was created by user visin at 9/6/2002 14:19:01, and can be read and written by all users. In some embodiments, the facility employs geographically-invariant times, such as times expressed in Greenwich Mean Time, in order to coordinate servers and clients located in different time zones. Where the server receives a retrieval request for fragment ID 894645, it uses row 801 to determine access permissions for this fragment.

While FIG. 8 and each of the table diagrams discussed below show a table whose contents and organization are designed to make them more comprehensible by a human reader, those skilled in the art will appreciate that actual data structures used by the facility to store this information may differ from the table shown, in that they, for example, may be organized in a different manner; may contain more or less information than shown; may be compressed, encrypted, and/or indexed; may contain a much larger number of rows than shown, etc.

FIG. 9 is a table diagram showing sample contents of a fragment version table used by the facility in some embodiments to store information about fragment versions. In particular, the facility uses the fragment version table to identify the different versions of a fragment that exist, and their time order. In some embodiments, the facility maintains only a single version of each fragment, in which case the fragment version table is not necessary, and fragment IDs are substituted for fragment version IDs in other tables maintained by the facility. The fragment version table 900 is made up of rows such as rows 901-903 each corresponding to a different fragment version. Each of the rows is divided into the following columns: a fragment version ID column 911 containing a fragment version ID for the fragment version to which the row corresponds that uniquely identifies this fragment version; a fragment ID column 912 containing the fragment ID identifying the fragment to which this fragment version corresponds; and an update time column indicating the time at which the fragment version was last updated. For example, row 901 indicates that the fragment version having fragment version ID 65489151 corresponds to the fragment having fragment ID 894645, and was last updated at 9/15/2002 9:17:12. Where the server receives a retrieval request for fragment ID 894645, it uses rows 901 and 902 to identify the two fragment versions that exist for this fragment ID. These two rows can also be used to determine which of the fragment versions is more recent.

In some embodiments, where fragment versions are used, some fragment versions are writeable, such that an author can change the content at a time after it is created, at least in the case of fragment versions that are not referenced by any pinned fragment references. However, in some embodiments, every fragment version is read-only, and any revision of content contained by an existing fragment version causes the facility to create a new fragment version. In various embodiments, the creation of a new fragment version occurs at various levels of granularity, including a new fragment version for each editing session, a new fragment version for each keystroke, or at some level in between, such as every five seconds, every minute, every 15 minutes, etc.

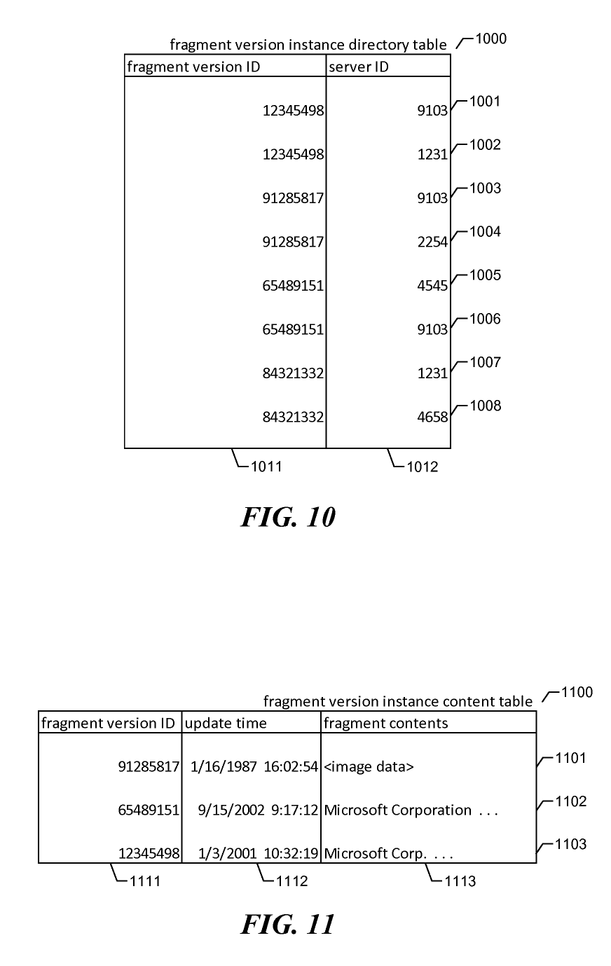

FIG. 10 is a table diagram showing sample contents of a fragment version instance table used by the facility in some embodiments to store information about fragment version instances. In particular, the facility uses the fragment version instance directory table to identify, for particular fragment version, instances of the fragment version that are stored on different servers, so that the facility can choose one of the fragment versions for retrieval, and so that, if a fragment version is being changed in an embodiment where this is possible, every instance of it can be changed or invalidated. The fragment version instance directory table 1000 is made up of rows such as rows 1001-1008 each corresponding to a different combination of a fragment version and a server on which an instance of the fragment version is stored. Each row is divided into the following columns: a fragment version ID column 1011 containing if fragment version ID identifying the fragment version; and a server ID column 1012 identifying a server on which an instance of the fragment version is stored. For example, row 1001 indicates that the fragment version having fragment version ID 12345498 has an instance stored on the server having server ID 9103. In various embodiments, the facility uses various other approaches to identifying locations in which instances of fragment versions are stored, such as by using data center IDs, storage device IDs, etc.

FIG. 11 is a table diagram showing sample contents of a fragment version instance content table used by the facility in some embodiments to store fragment version instance content. The fragment version instance content table 1100 is made up of rows such as rows 1101-1103 each corresponding to fragment version instances all stored on a particular server. The fragment version instance content table 1100 is, in particular, stored on the server having server ID 9103. Each of the rows is divided into the following columns: a fragment version ID column 1111 containing the fragment version ID identifying the fragment version to which the row corresponds; an update time column 1112 indicating the time at which the fragment version instance was last updated; and a fragment contents column 1113 containing the contents of the fragment version instance. For example, row 1101 indicates that the fragment version instance having fragment version ID 91285817 and update time 1/16/1987 16:02:54 contains particular image data. It is the fragment 1113 that contains the data that the facility returns in response to a fragment retrieval request.

In some embodiments, rather than storing each fragment version instance as a single entity as shown in FIG. 11, the facility employs an “erasure coding” technique in which it distributes the contents of each fragment version instance as any number of smaller shreds, which can be stored on any arrangement of servers.

### Metamorphic Documents

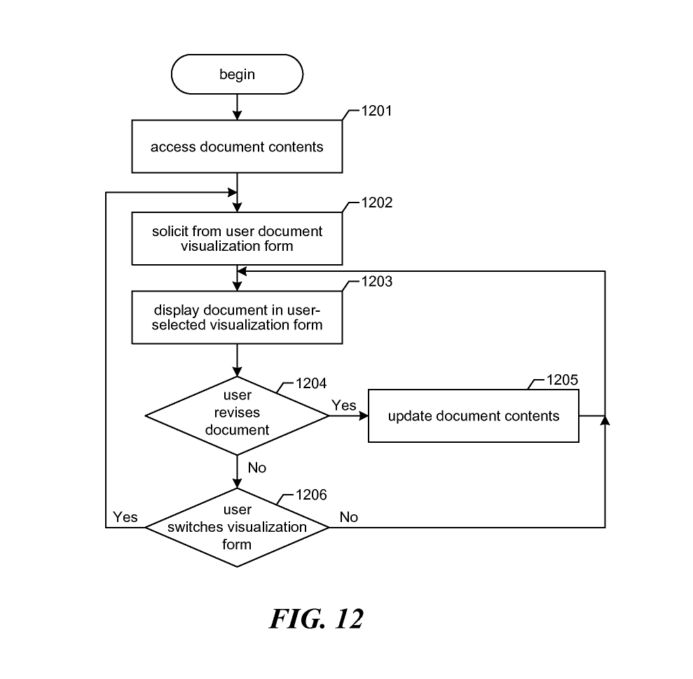

FIG. 12 is a flow diagram showing steps typically performed by the facility in some embodiments in order to provide access to documents in any of a number of available visualization forms selected arbitrarily by a user. In some embodiments, the facility performs these steps any time a document is opened or otherwise accessed by a user. In some embodiments, the facility performs these steps concurrently for two or more users who have all opened the same document; who can each view the document in his or her own visualization form; and whose revisions to the document are reflected to the other users who have the document open.

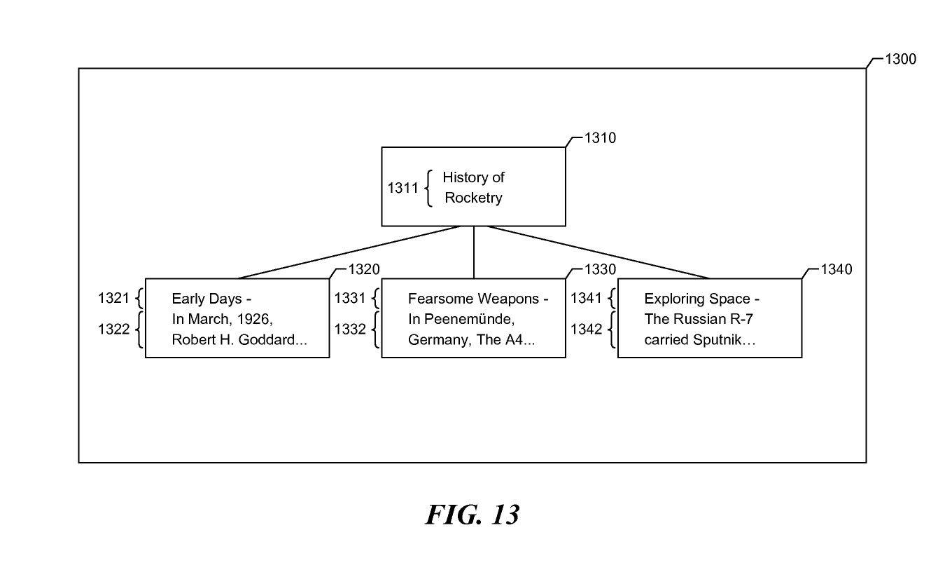

In step 1201, the facility accesses the contents of the document, such as in the manner above described with respect to the fragment management system. In step 1202, the facility solicits from the user an indication of a document visualization form to use to present and interact with the document. In various embodiments, the facility provides various sets of document visualization forms to the user for selection, such as via a user interface. In some embodiments, the facility initially automatically selects a document visualization form for the user based upon a variety of factors, but that form can subsequently be altered by the user. For example, in some embodiments, the facility automatically selects a document visualization form based on the last form used by the user, for this or another document; a default visualization form set by the user, a document author, or the facility; etc. In step 1203, the facility displays the document in the user-selected visualization form. Step 1203 is discussed in greater detail below in connection with FIGS. 13-20. In step 1204, if the user revises the document, then the facility continues in step 1205, else the facility continues in step 1206. In step 1205, the facility updates the contents of the document stored persistently, such as by the fragment management system. After step 1205, the facility returns to step 1204. In step 1206, if the user seeks to switch the present visualization form, then the facility returns to step 1202 to solicit from the user a new document visualization form in which to present and revise the document.

FIGS. 13-20 are display diagrams depicting an example in which multiple users concurrently edit a sample document in a variety of presentation forms.

FIG. 13 is a display diagram showing the sample document presented to a first user in fragment graph form. The display 1300 includes a graph of document nodes, such as document nodes stored as fragments within the fragment management system. A root fragment 1310 most centrally representing the document contains title text 1311 for the document, “History of Rocketry.” The root node has three child nodes, 1320, 1330, and 1340. Each of these child nodes represents a section of the document. Child node 1320 represents a first section of the document, and contains a section heading 1321 “Early Days,” and body text 1322 “In March, 1926, Robert H. Goddard . . . ” The other child nodes 1330 and 1340 themselves each contain title text 1331, 1341 and body text 1332, 1342. The first user may edit the document in this visualization form by deleting nodes, moving nodes, inserting nodes, splitting nodes, otherwise editing the content of nodes, etc.

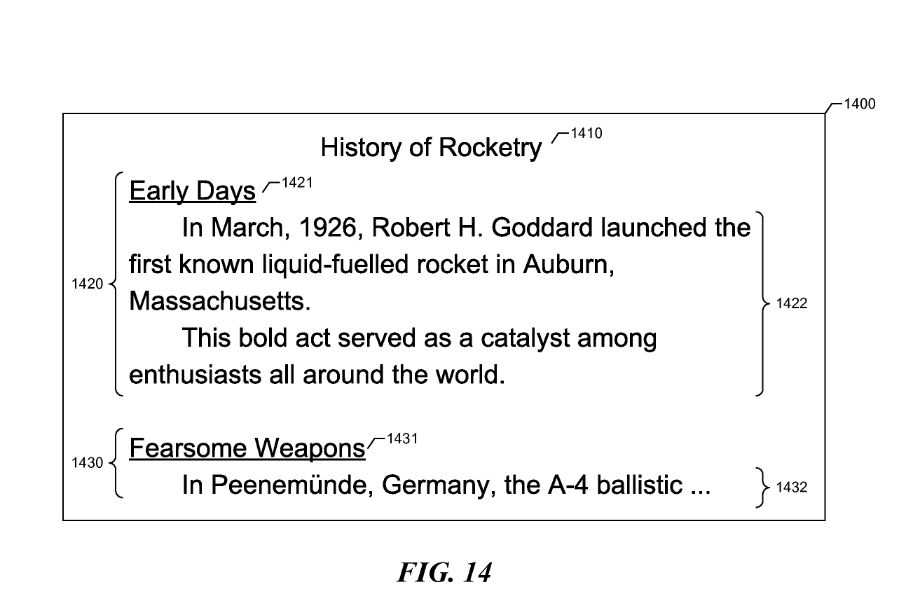

FIG. 14 is a display diagram showing presentation of the same document to a second user in a textual document visualization form. This display 1400 shows the document's title 1410 centered at the top of the page; headings 1421 and 1431 from nodes 1320 and 1330 of the fragment graph, respectively; and body text 1422 and 1432 from the same nodes. Like the first user, the second user can edit the document in this visualization form.

It will be appreciated that FIG. 14 is represented as being presented to a second user for illustration purposes, but that the disclosure is not limited thereby. For example, in some embodiments, the facility presents the display 1400 as a new visualization to the first user, for example, in response to the first user selecting a new visualization form. The first user can make revisions in any of the visualizations, and the facility will update the document contents, such that changes made in one visualization are still visible when the first user switches to a new visualization form.

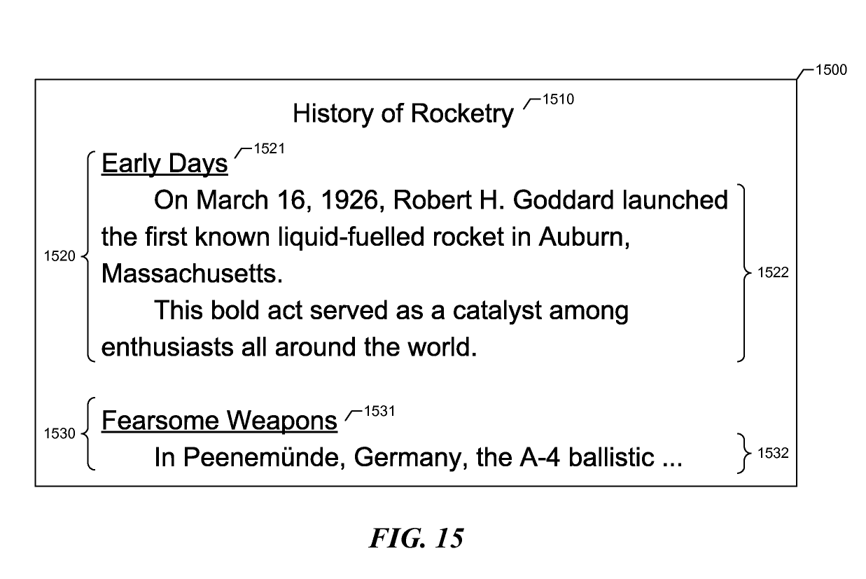

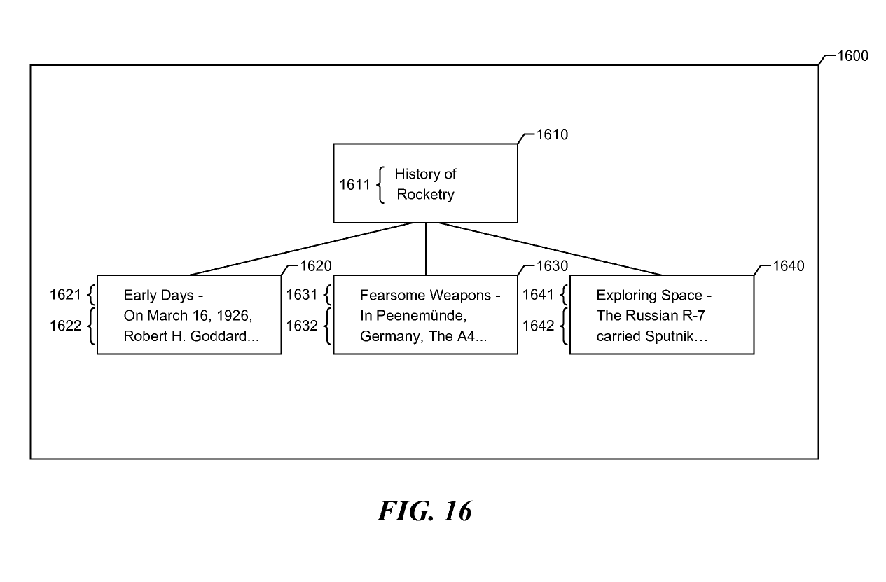

FIG. 15 is a display diagram showing a revision made to the document by the second user. In particular, the display 1500 reflects that the user has edited body text 1522 to read “On Mar. 16, 1926, . . . ” rather than “In March, 1926, . . . ” As a result of this revision, the facility updates the document contents for each of the group of users who has the document open, as illustrated, for example, by FIG. 16.

FIG. 16 is a display diagram showing the revision made by the second user as reflected in the fragment graph presentation of the document to the first user. It can be seen by comparing display 1600 to display 1300 that the body text 1622 of child node 1620 has been altered in accordance with the second user's revisions.

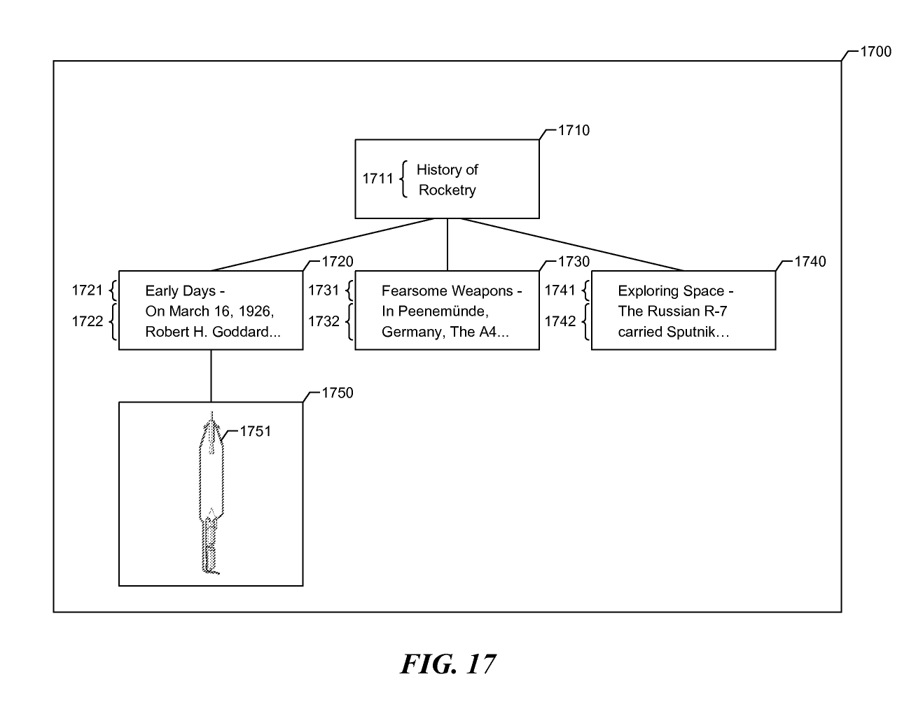

FIG. 17 is a display diagram showing a further revision to the document made by the first user. It can be seen by comparing display 1700 to display 1600 that the first user has modified the fragment graph to add a new node 1750 as a child of pre-existing node 1720. New node 1750 contains an image 1751 illustrating the section of the document to which node 1720 corresponds.

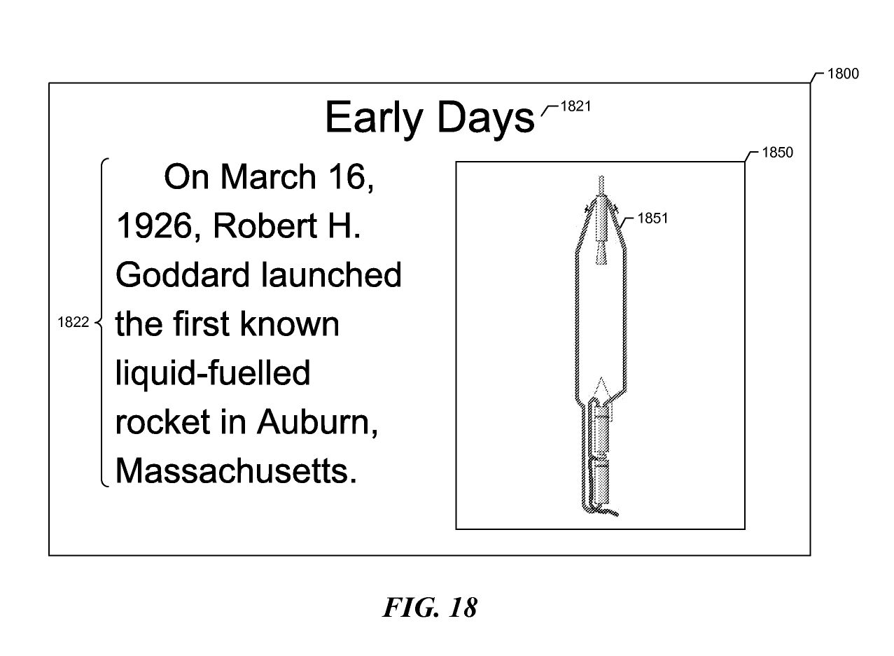

FIG. 18 is a display diagram showing presentation of the document to a third user. Display 1800 contains presentation of the document in a slideshow presentation form. In particular, the heading text 1821 from node 1720 is shown centered at the top of the page. The body text 1822 from node 1720 is shown on the left side of the page. And the image 1851 from node 1750 is shown on the right side of the page. As can be appreciated, in the slideshow context, the title from node 1710 may be presented on an earlier slide, rather than the slide depicted by display 1800. Thus, each visualization form can specify certain content appropriate for presentation in the context of that visualization form. Like the first two users, the third user can similarly revise the document in the visualization form that the third user has chosen.

It will be appreciated that FIG. 18 is represented as being presented to a third user for illustration purposes, but that the disclosure is not limited thereby. For example, in some embodiments, the facility presents the display 1800 as a new visualization to the first user, for example, in response to the first user selecting a new visualization form.

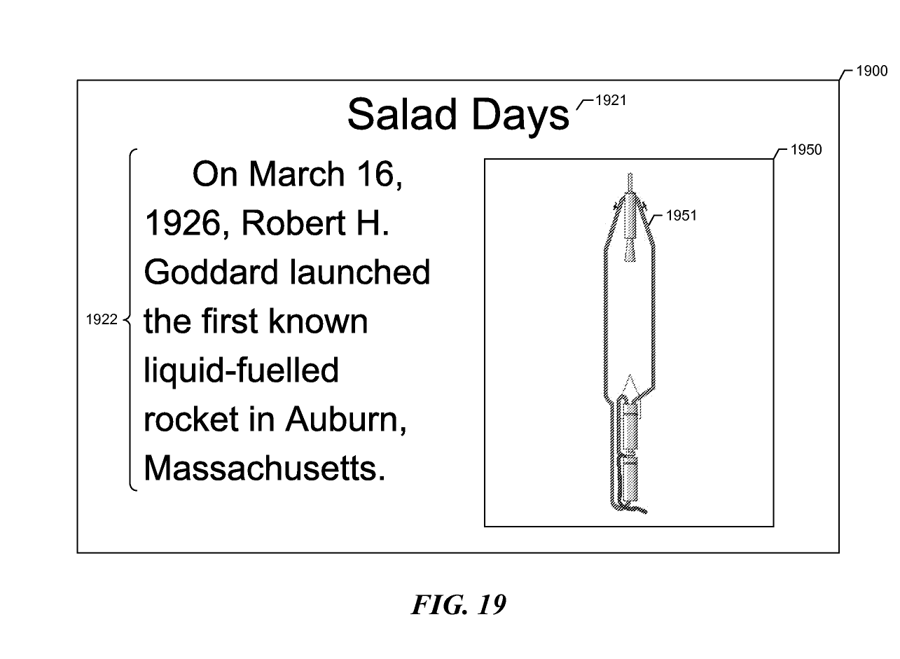

FIG. 19 is a display diagram reflecting a revision made to the document by the third user. By comparing display 1900 to display 1800, it can be seen that the third user has revised the heading text 1921 to read “Salad Days,” rather than “Early Days.”

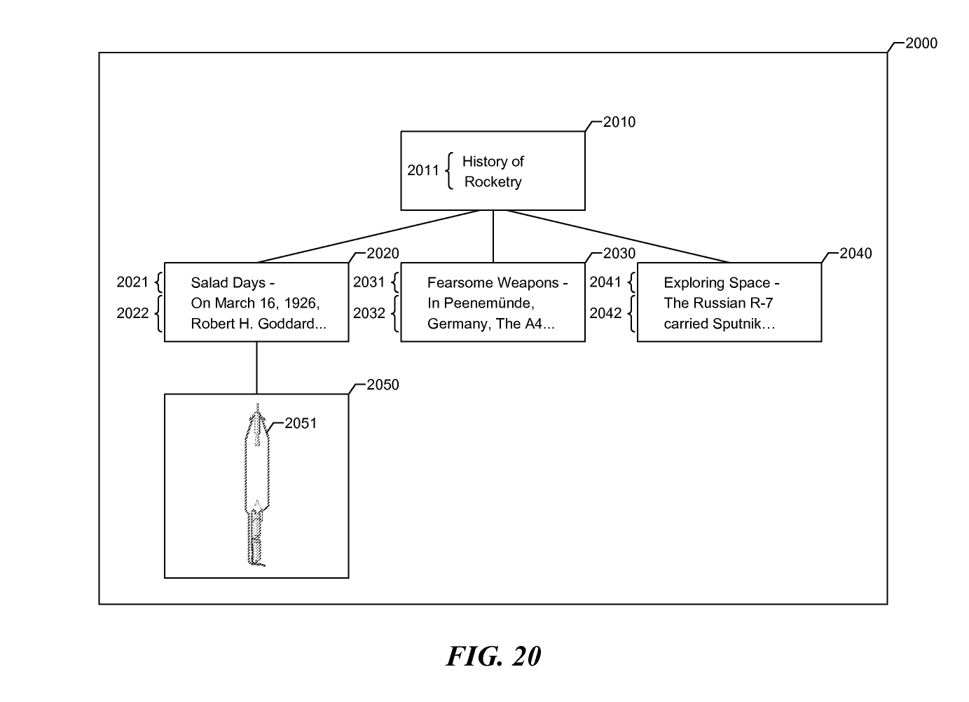

FIG. 20 is a display diagram showing the third user's revisions as reflected to the first user. By comparing display 2000 to display 1700, it can be seen that the heading text 2021 has been changed from “Early Days” to “Salad Days.” Like the other revisions, as a result of this revision, the facility has updated the document contents for each of the group of users who has the document open, as illustrated, for example, by FIG. 20.

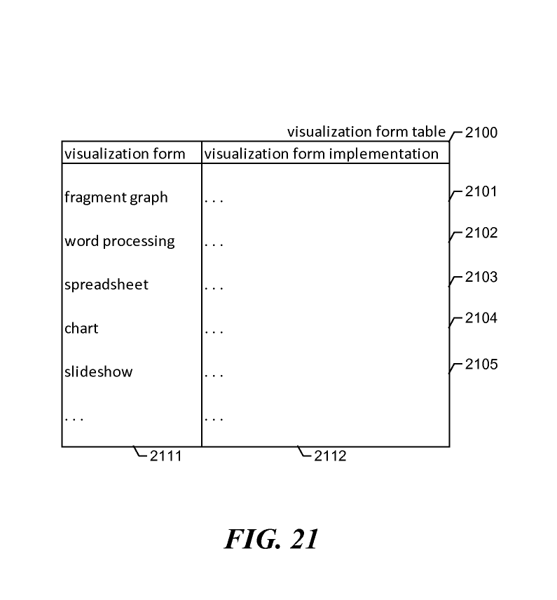

FIG. 21 is a table diagram showing sample contents of a visualization form table used by the facility in some embodiments to represent the set of visualization forms that are available for use by users to present documents. The visualization form table 2100 is comprised of rows such as rows 2101-2105, each corresponding to a different visualization form. Each row is made up of the following columns: a visualization form column 2111 containing information identifying the visualization form; and a visualization form implementation column 2112 containing information usable by the facility to present a document in a visualization form to which the row corresponds. In various embodiments, the facility stores in the visualization form implementation column code in a variety of languages for presenting a document in the visualization form; various kinds of pointers to code for this purpose; etc. For example, row 2101 contains in visualization form implementation column 2112 code for presenting a document in the fragment graph visualization form, or a pointer to such code.

In some embodiments, the facility provides a computing system for presenting document contents. The computing system comprises: an input subsystem configured to receive input denoting selection of one of a plurality of visualization forms; a rendering subsystem configured to render the document contents in accordance with the visualization form whose selection is denoted by input received by the input subsystem; and a display subsystem configured to cause the rendered document contents to be displayed. Each of these subsystems is a computing-related entity, comprising either hardware, a combination of hardware and software, software, or software in execution on a computer.

In some embodiments, the facility provides a method for presenting document contents. The method comprises: receiving input denoting selection of one of a plurality of visualization forms; rendering the document contents in accordance with the visualization form whose selection is denoted by the received input; and causing the rendered document contents to be displayed.

In some embodiments, the facility provides a computer-readable medium having contents configured to cause a computing system to, in order to collaboratively author a document: cause a portion of the document to be displayed to a first user in a first form; and, in response to receiving first input from the first user specifying a change to the portion of the document displayed to the first user in the first form: cause to be displayed to the first user in the first form the portion of the document changed in accordance with the first input, cause a persistent representation of the document to be altered in accordance with the first input, and cause to be displayed to a second user in a second form distinct from the first form a portion of the document changed in accordance with the first input.

In some embodiments, the facility provides a method for collaboratively authoring a document. The method comprises: causing a portion of the document to be displayed to a first user in a first form; and, in response to receiving first input from the first user specifying a change to the portion of the document displayed to the first user in the first form: causing to be displayed to the first user in the first form the portion of the document changed in accordance with the first input, causing a persistent representation of the document to be altered in accordance with the first input, and causing to be displayed to a second user in a second form distinct from the first form a portion of the document changed in accordance with the first input.

In some embodiments, the facility provides a computer-readable medium storing a data structure representing a document. The data structure comprises: a plurality of entries, each entry corresponding to a different one of a plurality of visualization forms, each entry comprising: first information identifying the visualization form to which the entry corresponds; and second information specifying a manner of transforming document contents into visualized document contents in accordance with the visualization form to which the entry corresponds, such that the contents of the data structure are usable to (a) solicit user input selecting one of the plurality of visualization forms to use in presenting distinguished document contents, and (b) transform the distinguished document contents into visualized document contents in accordance with the selected visualization form.

### CONCLUSION

It will be appreciated by those skilled in the art that the above-described facility may be straightforwardly adapted or extended in various ways. While the foregoing description makes reference to particular embodiments, the scope of the invention is defined solely by the claims that follow and the elements recited therein.

1. A computing system for presenting document contents, comprising:
an input subsystem configured to receive input denoting selection of one of a plurality of visualization forms;
a rendering subsystem configured to render the document contents in accordance with the visualization form whose selection is denoted by input received by the input subsystem; and
a display subsystem configured to cause the rendered document contents to be displayed.

2. The computing system of claim 1 wherein the input subsystem is further configured receive an input sequence denoting selection of a series of visualization forms in turn,
and wherein the rendering subsystem is configured to render the document contents in accordance with each of the series of visualization forms,
and wherein the display subsystem is configured to cause each instance of rendered document contents to be displayed.

3. The computing system of claim 1 wherein the input subsystem is configured to receive input from a first user, further comprising:
an updating subsystem configured to alter the rendered version of the document contents caused to be displayed by the display subsystem to reflect revisions denoted by input received from a second user.

4. The computing system of claim 1, further comprising a memory configured to store definitions of the plurality of visualization forms, at least one of the visualization forms defined by the stored definitions explicitly reflecting an organizational structure of the document contents.

5. The computing system of claim 4 wherein the input subsystem is further configured to receive second input denoting at least one revision to the displayed rendered document contents,
the computing system further comprising a revision subsystem configured to alter the organizational structure of the document contents in response to receipt of the second input by the input subsystem.

6. A computer-readable medium having contents configured to cause a computing system to, in order to collaboratively author a document:
cause a portion of the document to be displayed to a first user in a first form;
in response to receiving first input from the first user specifying a change to the portion of the document displayed to the first user in the first form:
cause to be displayed to the first user in the first form the portion of the document changed in accordance with the first input;
cause a persistent representation of the document to be altered in accordance with the first input; and
cause to be displayed to a second user in a second form distinct from the first form a portion of the document changed in accordance with the first input.

7. The computer-readable medium of claim 6 wherein the contents of the computer-readable medium are further configured to cause a computing system to:
in response to receiving second input from the second user specifying a change to the portion of the document displayed to the second user in the second form:
cause to be displayed to the second user in the second form the portion of the document changed in accordance with the second input;
cause a persistent representation of the document to be altered in accordance with the second input; and
cause to be displayed to the first user in the first form the portion of the document changed in accordance with the second input.

8. The computer-readable medium of claim 6 wherein the first form is a form that represents document organizational structure, and wherein the first input specifies a change to an organizational structure of the document.

9. The computer-readable medium of claim 6 wherein the portion of the document changed in accordance with the first input is caused to be displayed to the second user in the second form within 1 second of the display of the portion of the document to the first user in the first form changed in accordance with the first input.

10. A computer-readable medium storing a data structure, the data structure comprising:
a plurality of entries, each entry corresponding to a different one of a plurality of visualization forms, each entry comprising:
first information identifying the visualization form to which the entry corresponds; and
second information specifying a manner of transforming document contents into visualized document contents in accordance with the visualization form to which the entry corresponds,
such that the contents of the data structure are usable to (a) solicit user input selecting one of the plurality of visualization forms to use in presenting distinguished document contents, and (b) transform the distinguished document contents into visualized document contents in accordance with the selected visualization form.

11. The computer-readable medium of claim 10 wherein, in at least one of the rows, the second information comprises a pointer to code that is executable to transform the distinguished document contents into visualized document contents in accordance with the selected visualization form.

12. The computer-readable medium of claim 10 wherein, for the second information of an entry corresponding to a selected one of the plurality of visualization forms specifies a manner of transforming document contents into document contents visualized in accordance with a fragment graph visualization form.

13. The computer-readable medium of claim 10 wherein, for the second information of an entry corresponding to a selected one of the plurality of visualization forms specifies a manner of transforming document contents into document contents visualized in accordance with a word processing visualization form.

14. The computer-readable medium of claim 10 wherein, for the second information of an entry corresponding to a selected one of the plurality of visualization forms specifies a manner of transforming document contents into document contents visualized in accordance with a spreadsheet visualization form.

15. The computer-readable medium of claim 10 wherein, for the second information of an entry corresponding to a selected one of the plurality of visualization forms specifies a manner of transforming document contents into document contents visualized in accordance with a chart visualization form.

16. The computer-readable medium of claim 10 wherein, for the second information of an entry corresponding to a selected one of the plurality of visualization forms specifies a manner of transforming document contents into document contents visualized in accordance with a slideshow visualization form.

17. The computer-readable medium of claim 10 wherein, for the second information of an entry corresponding to a selected one of the plurality of visualization forms specifies a manner of transforming document contents into document contents visualized in accordance with a table of contents visualization form.

18. The computer-readable medium of claim 10 wherein, for the second information of an entry corresponding to a selected one of the plurality of visualization forms specifies a manner of transforming document contents into document contents visualized in accordance with an audio visualization form.

19. The computer-readable medium of claim 10 wherein, for the second information of an entry corresponding to a selected one of the plurality of visualization forms specifies a manner of transforming document contents into document contents visualized in accordance with a high contrast visualization form.

20. The computer-readable medium of claim 10 wherein, for the second information of an entry corresponding to a selected one of the plurality of visualization forms specifies a manner of transforming document contents into document contents visualized in accordance with a timeline visualization form.
